(19) United States
(12) Patent Application Publication
(10) Pub. No.: US 2005/0222894 A1
(43) Pub. Date: Oct. 6, 2005

(54) Universal transaction identifier

(76) Inventors: Moshe Klein, Woodland Hills, CA (US); Alon Shwartz, Woodland Hills, CA (US); Jim Zafrani, Woodland Hills, CA (US)

Correspondence Address: MARVIN H. KLEINBERG;Kleinberg & Lerner, LLP, Suite 1080, 2049 Centurv Park East., Los Angeles, CA, 90067, US

(21) Appl. No.: 10/898,464

(22) Filed: Jul. 23, 2004

Related U.S. Application Data
(60) Provisional application No. 60/500,811, filed on Sep. 5, 2003.

(51) Int. Cl. G06F 17/60

(52) U.S. Cl. 705/10; 705/1

(57) ABSTRACT

A method of correlating at least one data element used by at least one step of a business activity with an instance of said business activity, includes the steps of creating a unique identifier which is distinct from the data element, creating a data table of the data element associated to the unique identifier, identifying the data element used within the step, and correlating the step with the desired instance of said business activity utilizing the data element within the step, compiling a summary of the instance of the business activity and utilizing the summary to analyze the instance of the business activity.

This application claims priority based as a continuation in part of the provisional patent application Ser. No. 60/500,811 filed Sep. 05, 2003.

### BACKGROUND

1. Field of the Invention

The present invention relates to business processes, and more specifically to a system that permits the monitoring of each instance of a business activity within an IT infrastructure without the use of a single overarching unique identifier being passed amongst the various systems within the IT infrastructure.

2. Background of the Invention

Businesses operate via business activities, which are complex composites of sub- or micro-processes logically connected in the context of a common objective. For example, for a user of an internet website who is ordering a product, several different and distinct processes take place that all relate to the single transaction of purchasing the product. A web server delivers web pages with the requested content to the user. A database server provides some of the content. A credit card verification server ensures that payment is validated. A shipping server might take care of automating the shipping process. Finally, an inventory server could decrement the inventory list for the item demonstrating that one has been purchased. Any number of other servers and networked interactions can take place in effecting a single transaction.

In the prior art, no single solution could easily collect these distinct processes and actions into a cohesive whole. Prior art solutions require that a unique transaction identifier be include in each step of the process. Once the process has finished, the prior art solutions would then collect all of the information related to each individual transaction based upon the unique transaction identifier and some sort of reporting system to a central server.

Therefore, an effective solution is needed to allow a business to manage the activities in the enterprise and to allow decision makers access to relevant information in its appropriate context. Recently, a class of computer software programs known as enterprise governing systems have been developed to fulfill this need. An enterprise governing system is a software infrastructure which enables the execution of content sensitive real-time processes in the context of dynamic transactions. An enterprise governing system performs the tasks of synthesis, event handling, governing and action delivery. Synthesis is the ability to, in real-time, aggregate information form multiple sources into dynamic content-aware data structures based on sophisticated rules, complex data mappings and external events. Event handling validates, controls and executes a variety of different tasks, whether external or internal to the system. Governing is the ability to model monitor and execute complex processes. Action delivery is the ability to alert end-users with action-ready alternatives embedded within an existing application's user interface, and to automatically execute actions when required.

It is therefore an object of the present invention to provide a means by which a single transaction in a business activity may be uniquely identified without the use of a single systematic identifier code that needs to be instrumented and appended into all of the elements of the business activity. These and other objectives of the present invention will become apparent from the following description of the invention.

### SUMMARY OF THE INVENTION

A method of correlating at least one data element used by at least one step of a business activity with an instance of said business activity, includes the steps of creating a unique identifier which is distinct from the data element, creating a data table of the data element associated to the unique identifier, identifying the data element used within the step, and correlating the step with the desired instance of said business activity utilizing the data element within the step, compiling a summary of the instance of the business activity and utilizing the summary to analyze the instance of the business activity.

### BRIEF DESCRIPTION OF THE DRAWINGS

FIG. 1 is a block diagram showing the elements of a computer system which can be used to implement the present invention.

FIG. 2 illustrates the elements of a sample IT infrastructure that may be used by a business enterprise.

FIG. 3 illustrates a hypothetical IT infrastructure which employs the transaction identifier of the present invention.

FIG. 4 illustrates a sample data table used to identify transactions in the present invention.

FIG. 5 is a representation of the data elements used by present invention.

FIG. 6 illustrates the various data elements used by the monitoring and correlation server in a particular business activity.

FIG. 7 illustrates the elements of a sample IT infrastructure including the elements used by the monitoring and correlation server to correlate the information into a single business activity.

### DETAILED DESCRIPTION OF THE INVENTION

The present invention provides a method, implemented on a computer system, for uniquely identifying a single transaction within the context of a business activity without resorting to the use of a identifier code that is used by all processes that make up the business activity. In the following description, specific method steps and procedures are described in order to give a more thorough understanding of the present invention. In other instances, well known elements such as the computer's operating system and specific software functions are not described in detail so as not to obscure the present invention unnecessarily.

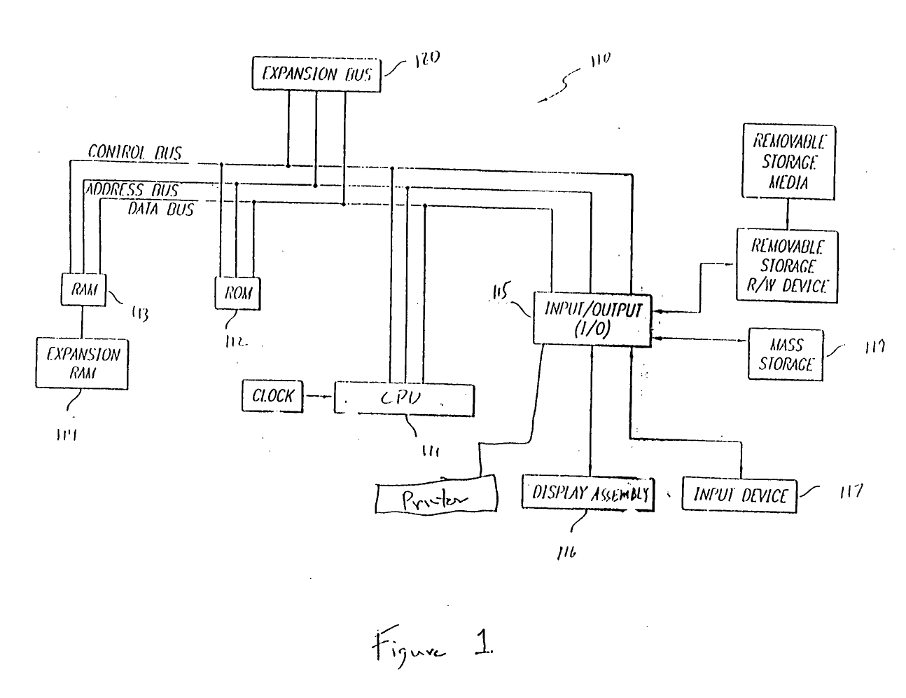

Referring first to FIG. 1, a block diagram of a general purpose computer system which can be used to implement the method of the present invention is illustrated. Specifically, FIG. 1 shows a general purpose computer system 110 for use in practicing the present invention. As shown in FIG. 1, computer system 110 includes a central processing unit (CPU) 111, read-only memory (ROM) 112, random access memory (RAM) 113, expansion RAM 114, input/output (I/O) circuitry 115, display assembly 116, input device 117, and expansion bus 120. The computer system 110 may also optionally include a mass storage unit 119 such as a disk drive unit or nonvolatile memory such as flash memory and a real-time clock 121.

Some type of mass storage 119 generally is considered desirable. However, mass storage 119 can be eliminated by providing a sufficient mount of RAM 113 and expansion RAM 114 to store user application programs and data. In that case, RAMs 113 and 114 can optionally be provided with a backup battery to prevent the loss of data even when computer system 110 is turned off. However, it is generally desirable to have some type of long term mass storage 119 such as a commercially available hard disk drive, nonvolatile memory such as flash memory, battery backed RAM, PC-data cards, or the like. The controlled vocabulary data which is stored in the present invention will be generally stored on mass storage device 119.

In operation, information is input into the computer system 110 by typing on a keyboard, manipulating a mouse or trackball, or “writing” on a tablet or on a position-sensing screen of display assembly 116. CPU 111 then processes the data under control of an operating system and an application program, such as a program to perform steps of the inventive method described above, stored in ROM 112 and/or RAM 113. CPU 111 then typically produces data which is output to the display assembly 116 to produce appropriate images on its screen.

Suitable computers for use in implementing the present invention are well known in the art and may be obtained from various vendors. The preferred embodiment of the present invention is intended to be implemented on a personal computer system or web server. Various other types of computers, however, may be used depending upon the size and complexity of the required tasks. Suitable computers include mainframe computers, multiprocessor computers and workstations.

The present invention can be utilized to enable a business enterprise to execute a business activity in a more efficient and cost-effective manner. The term “business activity” as used herein refers to a logically related series of processes or functions that are performed by the business enterprise in combination to achieve a desired goal. For example, a business activity can be as simple as taking an order from a customer, and delivering a product in response. On the other hand a business activity can be as complex as all of the functions performed by a financial advisor when giving advice to a client and managing a client's stock portfolio.

An “instance” of a business activity is all of the operations performed in completing one implementation of the business activity. For example, as described above the business activity could be taking an order online and delivering a product. An instance of that business activity could be one individual's order for a specific product processed from start to finish including all of the processes in between. A business activity is the general case, whereas an instance of a business activity is the specific case. The business activity includes all of the processes necessary to complete one business activity in the general, whereas an instance of a business activity is each of those processes performed in one specific instance. In the case of the financial advisor example, the business activity would be advising the client and all of the functions and processes necessary to reach that objective. The instance of the business activity would be advising a specific client, using those functions and processes toward the goal of advising a specific client. Another instance of that business activity would be the advising of a different client, and so on. Alternatively, an instance of a business activity may also be called a transaction. One transaction could be the purchase of the product online, whereas the business activity would be the general definition of the processes and functions necessary to purchase a product online.

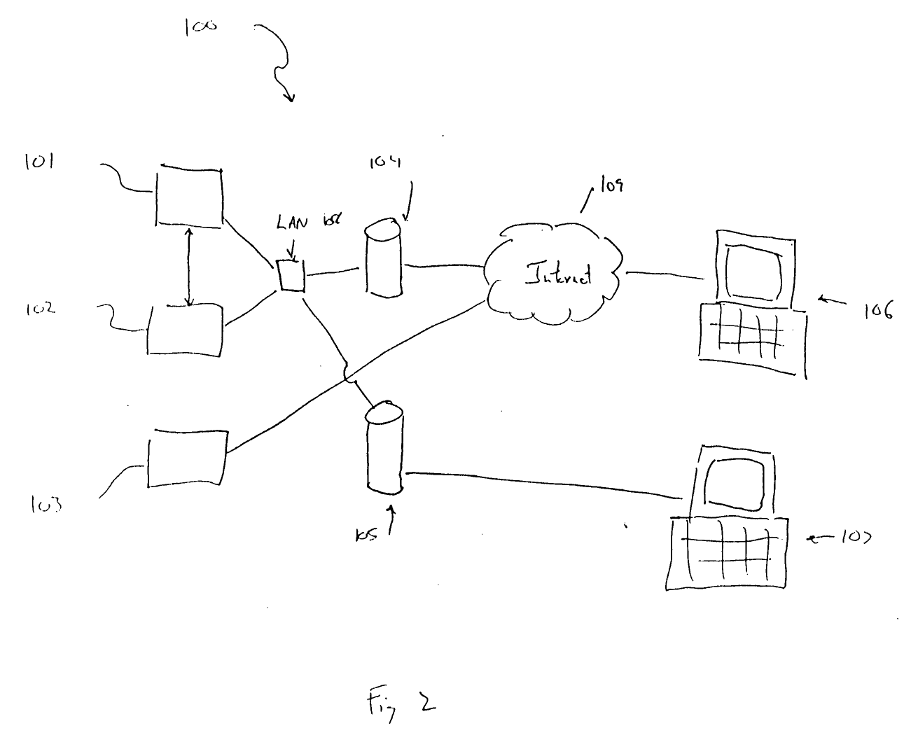

Many modern business activities are executed using a complex series of computers which make up an IT infrastructure. Referring next to FIG. 2, a representation of an example IT infrastructure 100 used by a business to complete a business activity is illustrated. The infrastructure may include a number of computer servers 101, 102, 103 which execute various functions or steps in a business activity. Although only three computer servers are illustrated in FIG. 2, it will be understood that a larger number of servers may be present in the infrastructure as required by the complexity of the business activity. The infrastructure may also include one or more databases 104, 105 for the storage and retrieval of data. Also Internet web servers 106, 107 may also be employed. Various other servers may also be included within an IT infrastructure.

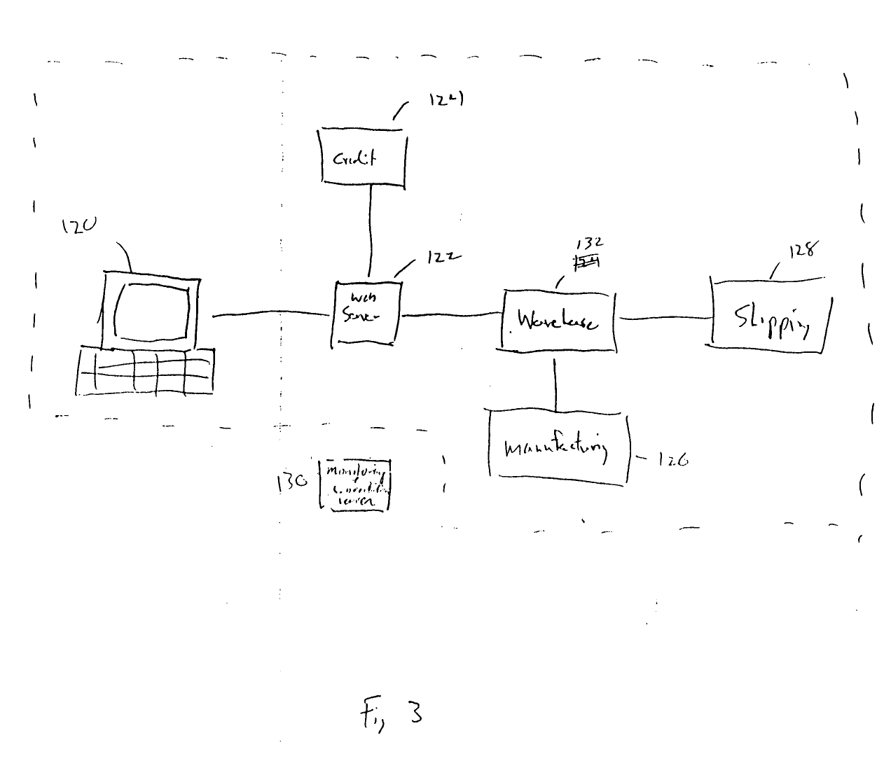

Referring next to FIG. 3 a representative IT infrastructure for a specific business activity is shown. Again, any number of additional or fewer servers and connections may be included in an actual implementation of this method. FIG. 3 is only shown as example. The example in FIG. 3 hypothesizes that a customer will place an order for a widget over the Internet using a credit card for payment. The business enterprise will then fulfill that order and ship the widget to the customer. The customer uses internet browser 120 to place the order. In doing so, the customer provides all of the necessary information to fulfill the order, including his name, shipping location, email address, credit card number and other information that may be required by the business to fulfill the order. The order is then passed to web server 122 where it is processed by the business. Web server 122 may contact credit card server 125 to verify the customer's payment. The business will then check inventory in its warehouse 124 to determine if the widget is available. If the widget is not in stock, then the manufacturing facility 126 is contacted to produce the item. Finally, the widget is shipped to the customer using an outside shipping service 128. The entire procedure is monitored by the monitoring and correlation server 130 which verifies the correct execution of the business activity and tracks the process of the transaction through the system and the IT infrastructure.

Each separate computer system illustrated in FIG. 3 will use different pieces of information to complete its portion of the business activity. For example, the credit card server 124 will require the credit card number of the customer to verify payment. The computer server for the manufacturing process 126 will not need that information, but will require data such as the specifications of the widget, and the quantity ordered. The various computer systems illustrated in FIG. 3 are not necessarily designed to share all data relating to the single transaction with each other. In some instances (such as the credit card server 124 and the shipping server 126) the elements of the IT infrastructure will not be maintained by the business enterprise, but will be owned and operated by outside vendors.

The IT infrastructure of a business enterprise is typically not designed to provide a single unique identifier code for each function or process that is part of a business activity. This is because the various elements that make up the IT infrastructure are not programmed to accept the exact same data elements and structures from all of the other elements of the infrastructure. Thus, there is no way to be certain that a unique identifier code will be passed among the various elements.

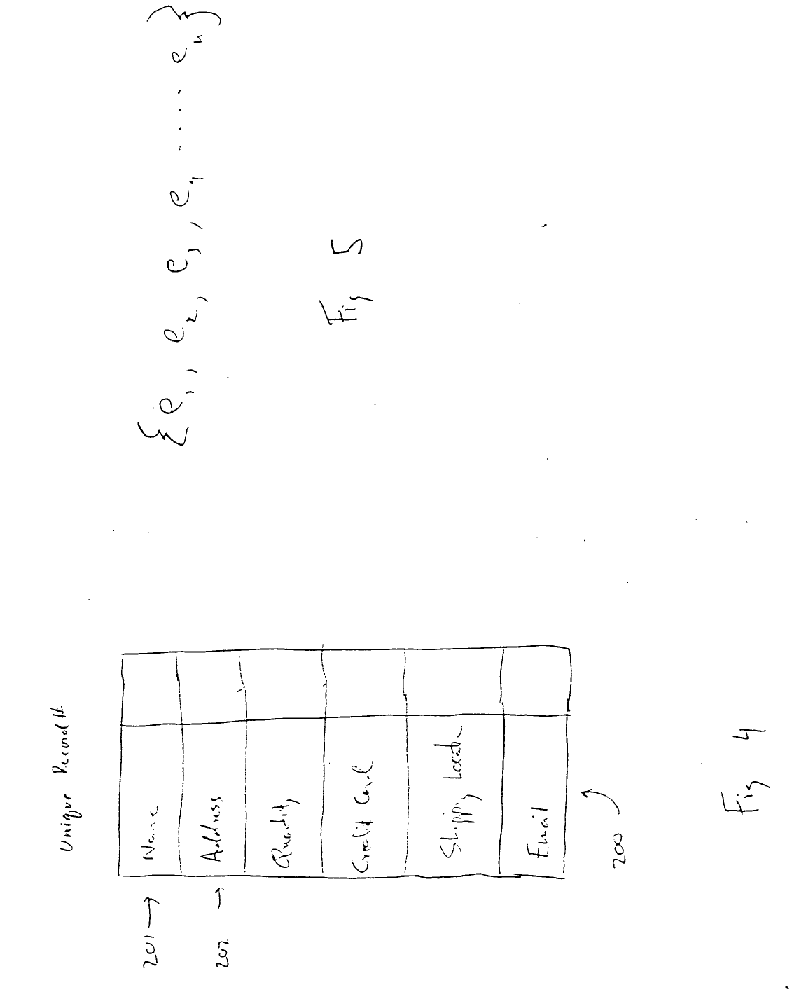

In the preferred embodiment of the present invention, each time a new transaction (or instance of a business activity) is started, the monitoring and correlation server 130 generates a unique transaction identifier and data record for the business activity. This unique transaction identifier is distinct from the prior art in that it is only maintained on the monitoring and correlation server 130. The unique transaction identifier is not passed between the various elements of the IT infrastructure. Instead, as described below, the monitoring and correlation server 130 is used to correlate data elements that are contained in a single unique transaction identifier's data record with that unique transaction identifier and thus, with the transaction. Referring next to FIG. 4, a representative unique transaction identifier data record 200 is shown. Using the hypothetical example of FIG. 3, specific data elements 201, 202, etc. are shown. The monitoring and correlation server 130 maintains a database which lists all of the separate data records containing data elements in a unique record for each instance of the business activity.

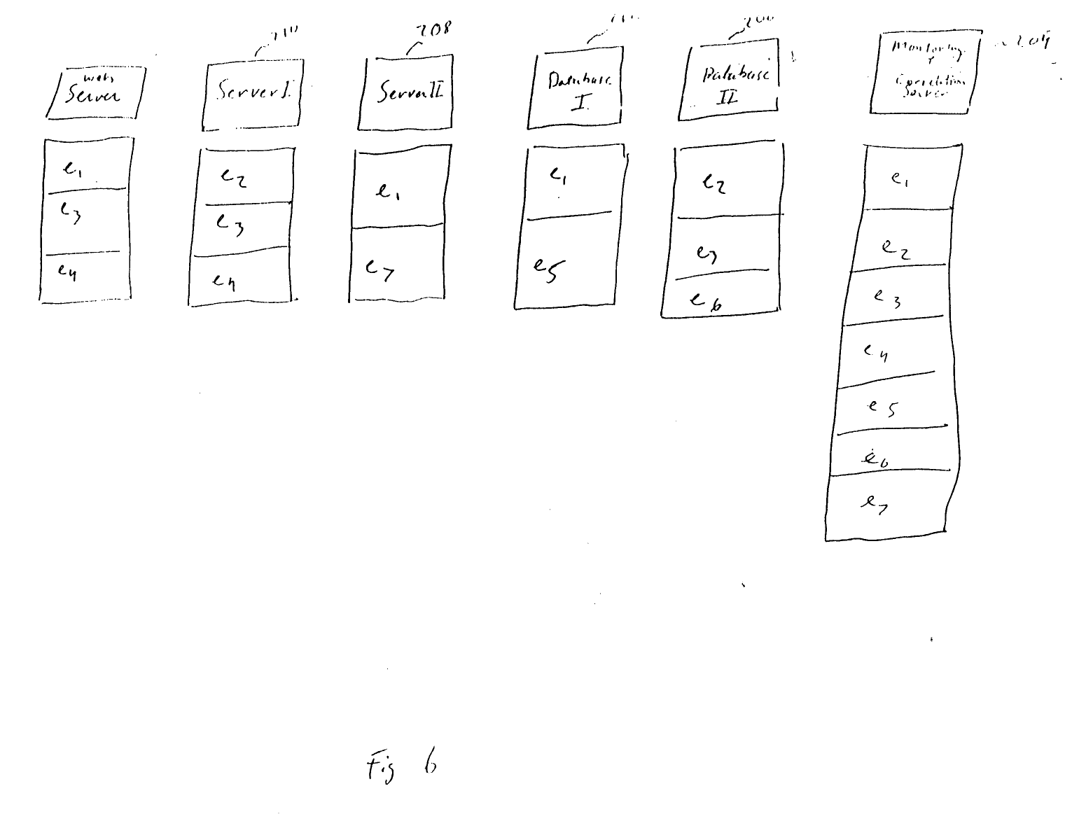

The data elements can be generically represented by the terms e₁, e₂, e₃, . . . , eₙ as shown in FIG. 5. The business activity may use one or more of the data elements in each step as the process is executed. Referring again to FIG. 3, each step in the business activity uses different elements of the overall data table 200. The monitoring and correlation server 130 monitors each step of the business activity. Whenever data is passed among the elements of the IT infrastructure shown in FIG. 3, the monitoring and correlation 130 will monitor the data that is exchanged. The monitoring and correlation server 130 is able to extract the various elements (eₙ) that are used by the various portions of the infrastructure. The specific elements that are used at each step can be uniquely correlated to a single data record which is stored in a database that can be accessed by the monitoring and correlation server 130. This permits the progress of each step or single transaction (within each instance of a business activity) to be monitored and tracked without the use of a unique identifier code.

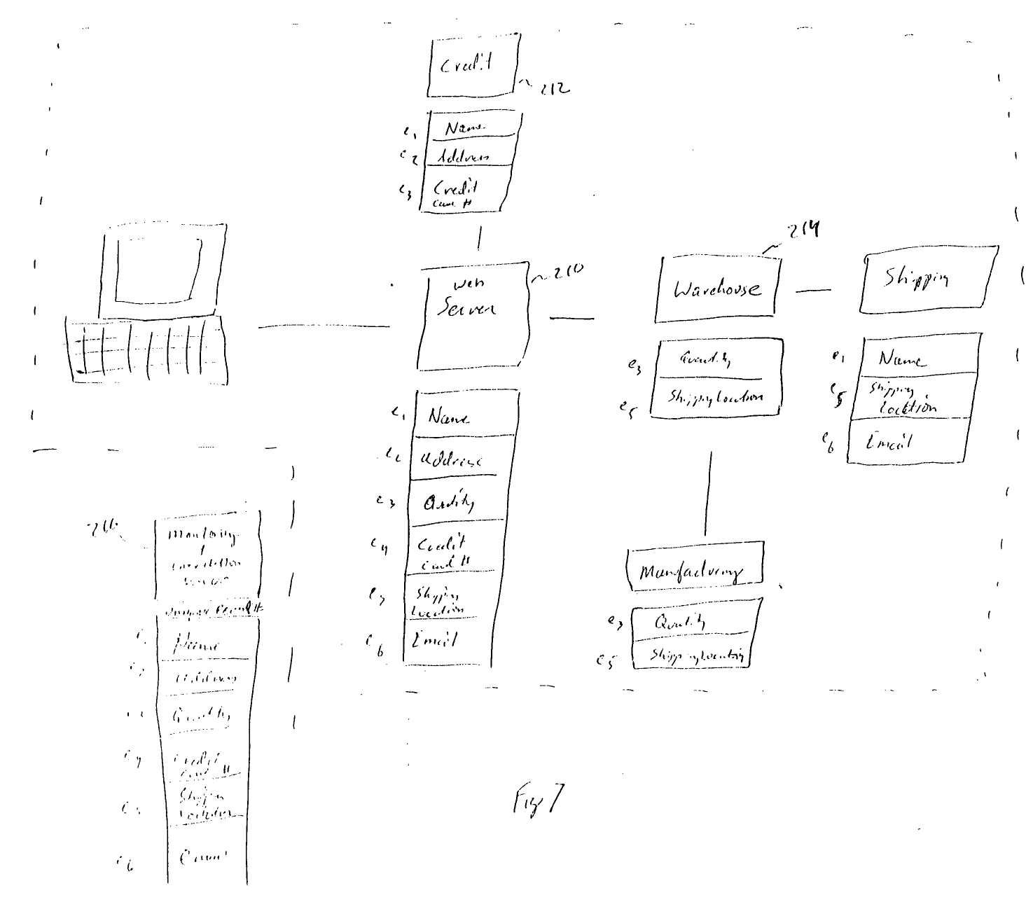

For example in FIG. 6, a different view of a similar generic IT infrastructure is shown. Server I 210 and server II 206 each perform different processes within the business activity. Similarly, database I 212 and database II 206 each perform different processes within the business activity. These servers and databases do not share any unique transaction identifier and may be completely different or substantially incompatible types of systems. The data elements used by the various systems in the infrastructure are generically represented by the terms e₁, e₂, e₃, . . . , eₙ. In this example infrastructure, the various systems utilize different data elements throughout a single business activity. No single data element is shared across all of the components of the IT infrastructure and there is often no overlap of the data elements in the different components of the IT infrastructure. For example, server II 208 uses only the data elements e₁ and e₇, whereas database II 206 uses only the data elements e₂, e₃ and e₆.

At the outset, the monitoring and correlation server 204 is set to monitor particular data elements used by the processes within the business activity. As the monitoring and correlation server 204 monitors and encounters these elements, it compares those elements with the unique data records created for each instance of a business activity. The combination of the elements, when compared with the unique records created by this method is sufficient to correlate the various data being passed back and forth in the individual steps across the IT infrastructure with a single transaction (or instance of a business activity) and its unique identifier. As in the example of FIG. 6, when e₁ and e₇ are passed in the same data flow utilized by Server II 208, the monitoring and correlation server 204 then compares those two elements to its unique data records and determines that the data flow correlates to a particular transaction containing e₁ and e₇.

Typically, one element would not be sufficient to correlate a particular data flow with a particular transaction. When special data such as a timestamp of the transaction's start time or when a very unique piece of information such as a social security number is given, this alone might be sufficient to perform the correlation. However, a single unique data element is not always sufficient to identify and correlate a process with a particular instance of a business activity. For example, if the social security number is passed, but there are currently five transactions in this business activity pending which all include that social security number, then the correlation will not be possible based solely upon this unique data element. The monitoring and correlation server 204 will hold the information concerning that process until it receives more data pertaining to that transaction which will enable it to correlate the process with the transaction.

In addition, the the monitoring and correlation server 204 can be made aware of the dependencies between each of the data elements by an administrator. It is then able to apply those dependencies in business activities where data can be received by the monitoring and correlation server 204 out of order. For example, data element e₃ may be dependent on data element e₂ before the correlation can be performed. In such instances, the monitoring and correlation server 204 will attempt to perform the correlation for e₃ and, if it can not find any transaction, it will read the dependency information for e₃, determine that e₃ is dependent upon e₂ and will retain the information associated with e₃ for a predefined period of time to allow e₂ to be received and the correlation to be processed accordingly. Once e₂ has been received and processed, the monitoring and correlation server 204 will then combine the dependent e₃ with e₂ and correlate the elements with the proper transaction.

Events which include particular data elements can also be pre-flagged by a user as data elements that mark the beginning of a transaction or the end of a transaction. The designation of an event that starts a transaction is important for the purpose of understanding when a new transaction has been started and a new unique identifier must be generated by the monitoring and correlation server 204. The same applies for events that mark the end of a transaction so that the monitoring of the transaction by the monitoring and correlation server 204 could stop and the unique identifier released. The monitoring and correlation server 204 will apply special handling of events containing data elements that designate the start or end of a transaction.

For events designating the start of a transaction, the monitoring and correlation server 204 will be able to apply logic that allows the data elements specific to that starting event to join an existing transaction if so marked. The usual handling will generate a new transaction and automatically end any previous transaction that contains the same data element. In some cases, however, the repeating of the data element is a normal operation of the transaction being monitored. In those cases, the data element will be correlated to the existing transaction that already contains the data element.

Special handling is also applied to events containing data elements that have been flagged as ending a transaction. In most cases, once the transaction-ending data element has been matched to an existing transaction, the transaction will be closed and no other data elements will be correlated to that transaction. In some cases, however, it is necessary for the transaction to persist for a predefined amount of time and allow other data elements to be correlated with the transaction. This handling is predefined by the administrator of the monitoring and correlation server 204 on the basis of the type of business activity that is being modeled and monitored.

Referring now to FIG. 7, we see the data elements each piece of an IT infrastructure will possess during an example business activity. This IT infrastructure is only shown as an example IT infrastructure. Many other embodiments of an IT infrastructure that the present invention is capable monitoring and correlating are present in the art. Any of the virtually infinite number of permutations of different IT infrastructures can be monitored by the method of this invention.

In FIG. 7, the IT infrastructure is outlined in dotted lines while the the monitoring and correlation server 216 is outside of the IT infrastructure. In this activity, during Step 1, the Web Server 210 takes all of the information from the client for the order. Then, the monitoring and correlation server 216 automatically generates a unique record number and a record containing as many identifiable data elements as possible. In alternative embodiments, fewer data elements could be used, though these embodiments would be inferior to one using as many data elements as possible. This information is obtained by monitoring web sever 210 and determining the data elements that have been collected by web server 210. In Step 2 of the transaction, three data elements are sent to an offsite credit server 212 to validate the credit charge. For this transaction only the data elements e₁, e₂ and e₃ are used; Name, Address, and Credit Card Number respectively. Monitoring and correlation server 216 though its monitoring of the credit server 212 collects the three data elements and then matches them to the unique record number for that transaction. In Step 3, three data elements are sent to the warehouse server 214 in order to request a particular item in a certain number to be sent to a particular address. In this case, only two elements are sent e₃ and e₅; Quantity and Shipping Location respectively. Through the monitoring of the warehouse server 214, monitoring and correlation server 216 collects these data elements and matches them with the two corresponding data elements in its unique record. In Steps 4 and 5, the data elements are matched in much the same way. Should one of the servers send back relevant information that monitoring and correlation server 216 mid-business activity, that is relevant to its correlation processes; it will also be added to the unique record by monitoring and correlation server 216 and later used to aid in future correlation. An example of such data would be if the shipping server returns a tracking number. The tracking number would then be included in the unique record and would be another item capable of being matched to other transactions. Steps 4 and 5 occur in much the same way.

At the end of this method the individual processes are all correlated to the unique record and are thus identifiable to the user as all being a part of one transaction (or instance of a business activity) from start to finish across an entire IT infrastructure. The ability to match these individual processes with an instance of a business activity results in a complete record of a single instance of a business activity from start to finish across the complete IT infrastructure without having the unique identifier included in each step of the transaction.

The data from this complete record of a single instance of a business activity could be compiled in real time and displayed graphically, digitally on a computer screen or by some other means. This data would provide a complete description of an entire instance of a business activity from start to finish and the results of each step in the instance of the business activity. Also, all of the instances of a particular business activity may be compiled in real time into aggregate records including all individual business activities, such as all purchases of a product in a particular way. These records could demonstrate any number of things related to the instances of a business activities or the business activity as a whole. Finally, all business activity aggregate records could be compiled and displayed or manipulated by some means for each business activity. The universal transaction identifier provides the means by which such evaluations and actions may be taken based upon individual instances of business activities, aggregate data concerning business activities, or entire groups of business activities.

Accordingly, a universal transaction identifier has been described. It is to be understood that the foregoing description has been made with respect to specific embodiments thereof for illustrative purposes only. The overall spirit and scope of the present invention is limited only by the following claims, as defined in the foregoing description.

1. A method of correlating the execution of at least one step of a business activity with an instance of the business activity, comprising the steps of:
monitoring at least one computer server executing at least a portion of the at least one step of the business activity:
identifying at least one data element used within said the at least one step of the business activity; and
correlating the at least one step of the business activity with the instance of the business activity wherein said correlating is accomplished by utilizing said at least one data element.

2. The method of claim 1, further comprising the initial step of creating a unique identifier external to said at least one data element.

3. The method of claim 2, wherein said creating step further includes the creation of a data table of said at least one said data element associated to said unique identifier.

4. The method of claim 1, further comprising the step of repeating the method of claim 1 for multiple the instances of the business activity.

5. The method of claim 1, further comprising the step of compiling the at least one step of the said instance of the business activity into a summary of said instance of said business activity.

6. The method of claim 5, further comprising the step of compiling said summary into an aggregate summary of at least one of the instance of the business activity.

7. The method of claim 4, further comprising the step of compiling the at least one step of the instance of the business activity into a summary of the instance of the business activity.

8. The method of claim 7, further comprising the step of compiling said summary into an aggregate summary of at least one of the instance of the business activity.

9. The method of claim 7, further comprising the step of using said summary of said instance of said business activity to determine the outcome of the at least one step within the instance of the business activity.

10. The method of claim 8, further comprising the step of using said aggregate summary of the at least one step of at least one instance of said business activity to determine the outcome of the instance of the business activity.

11. The method of claim 7, further comprising the step of using said summary of said at least one step of the instance of the business activity to analyze the business activity.

12. The method of claim 8, further comprising the step of using said aggregate summary of at least one the instance of the business activity to analyze the business activity.

13. The method of claim 1, wherein said identifying step is accomplished by means of passive monitoring of network traffic surrounding said business activity.

14. The method of claim 1, wherein said correlating step is accomplished by means of a comparison between said at least one data element and data elements associated with the instance of the business activity.

15. The method of claim 2, wherein said correlating step is accomplished by means of a comparison between said at least one data element and at least one data element associated with said unique identifier.

16. The method of claim 3, wherein said correlating step is accomplished by means of a comparison between said at least one data element and said data table.

17. The method of claim 3, wherein said identifying step is accomplished using a table of data elements.

18. The method of claim 3, wherein said correlating step is accomplished using a table of data elements.

19. The method of claim 17, wherein said table is external to said instance of said business activity.

20. The method of claim 18, wherein said table is external to said instance of said business activity.

21. The method of claim 1, wherein said at least one data element includes information concerning said step.

22. The method of claim 1, wherein said at least one data element includes information concerning the said instance of the business activity.

23. A method of correlating the execution of at least one step of a business activity with an instance of the business activity, comprising the steps of:
monitoring at least one computer server executing the at least one step of the business activity;
creating a unique identifier external to the instance of the business activity;
identifying at least one data element used within the at least one step of the business activity; and
correlating the at least one step of the business activity with the instance of said the business activity wherein said correlating is accomplished by utilizing said at least one data element.

24. A method of correlating the execution of at least one data at least one step of a business activity with an instance of the business activity, comprising the steps of:
monitoring at least one computer server executing the at least one step of the business activity;
creating a unique identifier external to the instance of the business activity;
identifying at least one data element used within the at least one step of the business activity;
correlating the at least one step of the business activity with the instance of the business activity wherein said correlating step is accomplished utilizing said at least one data element; and
creating a data table of the at least one step associated with said unique identifier.

25. A method of correlating the execution of at least one step of a business activity with an instance of the business activity, comprising the steps of:
monitoring at least one computer server executing the at least one step of the business activity;
creating a unique identifier external to the instance of the business activity;
identifying at least one data element used within said at least one step of the business activity;
correlating the at least one step of the business activity with the instance of the business activity utilizing said at least one data element within said step;
creating a data table of the at least one step associated with said unique identifier; and
compiling a summary of the instance of the business activity.

26. A method of correlating the execution of at least one step of a business activity with an instance of said business activity, comprising the steps of:
monitoring at least one computer server executing the at least one step of the business activity;
creating a unique identifier external to the instance of the business activity;
identifying at least one data element used within said at least one step of the business activity;
correlating the at least one step of the business activity with the instance of the business activity utilizing said at least one data element within said step;
creating a data table of the at least one step associated with said unique identifier;
compiling a summary of said instance of said business activity; and
utilizing said summary of said instance of said business activity to analyze the instance of said business activity.

27. A method of monitoring an IT infrastructure, said infrastructure including at least a plurality of processes comprising the steps of:
monitoring each of said processes within said IT infrastructure for at least one data element associated with an instance of a business activity;
utilizing said at least one data element to correlate said process with said instance of said business activity.

28. The method of claim 27, further comprising the initial step of creating a unique identifier external to said IT infrastructure for each of said instances of said business activity.

29. The method of claim 28, where in said creating step further comprises the creating of a data table of said at least one data element.

30. The method of claim 29, further comprising the step of adding data elements to said data table.

31. The method of claim 27, further comprising the step of compiling at least one of said correlated processes into a record of said instance of said business activity.

32. The method of claim 31, further comprising the step of compiling at least one of said record of said instance of said business activity into a record of said business activity.

33. The method of claim 31, further comprising the step of using said record of said instance of said business activity to evaluate said instance of said business activity.

34. The method of claim 32, further comprising the step of using said record of said business activity to evaluate said business activity.

35. The computer-based apparatus for identifying individual steps and for correlating said individual steps in an instance of a business activity with the instance of a business activity comprising:
means for identifying said steps, and
means connected to said means for identifying said steps for correlating said steps to an instance of said business activity.

36. The apparatus of claim 35, wherein said means for identifying said steps includes a monitoring server.

37. The apparatus of claim 35, wherein said means for correlating said steps includes a correlating server.

38. The apparatus of claim 35, further comprising means for summarizing said instance of said business activity.

39. The apparatus of claim 38, wherein said means for summarizing said instance of said business activity further comprises a means connected to said summarizing means for including said steps in said summary.

40. The apparatus of claim 39, further comprising means connected to said means for summarizing said instance of said business activity for compiling each of said instances of said business activity into an aggregate summary.

41. The apparatus of claim 40, further comprising means connected to said means for compiling each of said instances of said business activity into a business activity summary.

42. The apparatus of claim 35 wherein said means for identifying includes means connected to said identifying means for identifying data elements within said steps.

43. The apparatus of claim 36, wherein said monitoring server includes a means for identifying data elements within said steps.

44. The apparatus of claim 35, wherein said means for correlating includes means connected to said correlating means for correlating data elements within said steps.

45. The apparatus of claim 35, wherein said means for identifying further comprises a unique identifier means external to said business activity.

46. The apparatus of claim 45, further comprising an additional data table means connected to said unique identifier means for storing data elements related to said unique identifier.

47. The apparatus of claim 35, wherein said means for correlating further comprises a unique identifier means external to said business activity.

48. The apparatus of claim 47, further comprising an additional data table means connected to said unique identifier means for storing data elements related to said unique identifier.

49. A digital computer system programmed to perform the steps specified in the method of claim 1.

50. (canceled)

51. (canceled)

52. (canceled)

53. (canceled)

54. (canceled)

55. (canceled)

56. (canceled)

57. (canceled)

58. (canceled)

59. Computer-readable media containing instructions for performing the steps specified in the method of claim 1.

60. A method of correlating the execution of steps within a business activity with an instance of the business activity, comprising the steps of:
(a) monitoring one or more computer servers, said computer servers executing a plurality of the steps which make up at least a portion of the business activity;
(b) identifying at least one data element used within each of said plurality of steps of the business activity; and
(c) correlating the plurality of steps of the business activity with the instance of the business activity, wherein said correlating is accomplished by utilizing said data elements identified in step (b).

61. The method of claim 60, wherein a plurality of distinct data elements are identified in step (b).

62. The method of claim 60 further comprising the step of creating a unique identifier, said unique identifier being distinct from said data element identified in step (b).

63. A digital computer system programmed to perform the steps recited in claim 60.

64. Computer-readable storage media which contains instructions to direct a computer to performing the steps recited in claim 60.

65. A method of correlating the execution of steps within a business activity with an instance of the business activity, comprising the steps of:
(a) monitoring one or more computer servers, said computer servers executing the plurality of steps which make up the business activity;
(b) creating a unique identifier external to the instance of the business activity;
(c) identifying at least one data element used within each of the plurality of steps of the business activity; and
(d) correlating the plurality of steps of the business activity with the instance of the business activity wherein said correlating is accomplished by utilizing one or more of said data elements identified in step (c).

66. The method of claim 65, wherein a plurality of distinct data elements are identified in step (c).

67. A method of correlating the execution of at least some of the processes which make up a business activity with an instance of the business activity, comprising the steps of:
(a) monitoring computer servers which execute at least some of the processes which make up the business activity;
(b) identifying at least one data element used within a process of the business activity;
(c) repeating step (b) for selected processes which make up the business activity; and
(d) correlating each process of the business activity which was monitored in step (a) with the instance of the business activity, wherein said correlation is accomplished utilizing said data elements identified in steps (b) and (c).

68. The method of claim 67 wherein a distinct data element is identified in steps (b) and (c) for each of the processes monitored in step (a).

69. The method of claim 67 wherein at least some of the data elements identified in steps (b) and (c) may be identical to each other.

70. The method of claim 67 further comprising the step of creating a unique identifier, said unique identifier being distinct from said data element identified in steps (b) and (c).

71. A method of correlating the execution of the plurality of processes which make up a business activity with an instance of the business activity, comprising the steps of:
(a) monitoring at least one computer server which executes the process which make up the business activity;
(b) identifying at least one data element used within a process of the business activity;
(c) repeating step (b) for each of the processes which make up the business activity; and
(d) correlating each of the process that make up the business activity with the instance of the business activity, wherein said correlation is accomplished utilizing said data elements identified in steps (b) and (c).

72. The method of claim 71 wherein a distinct data element is identified in steps (b) and (c) for each of the processes that make up the business activity.

73. The method of claim 71 wherein at least some of the data elements identified in steps (b) and (c) may be identical to each other.

74. A method of correlating the execution of at least some of the processes which make up a business activity with an instance of the business activity, comprising the steps of:
(a) monitoring computer servers which execute at least some of the processes which make up the business activity;
(b) identifying at least one data element used within a process of the business activity;
(c) repeating step (b) for selected processes which make up the business activity, wherein at least some of said data elements identified in steps (b) and (c) may be identical to each other;
(d) creating a unique identifier, said unique identifier being distinct from said data element identified in steps (b) and (c);
(e) correlating each process of the business activity which was monitored in step (a) with the instance of the business activity, wherein said correlation is accomplished utilizing said data elements identified in steps (b) and (c).

75. A digital computer system programmed to perform the steps recited in claim 71.

76. Computer-readable storage media which contains instructions to direct a computer to performing the steps recited in claim 74.
